(19) United States
(12) Patent Application Publication
(10) Pub. No.: US 2019/0179796 A1
(43) Pub. Date: Jun. 13, 2019

(54) METHOD OF AND SYSTEM FOR GENERATING A TRAINING SET FOR A MACHINE LEARNING ALGORITHM

(71) Applicant: YANDEX EUROPE AG, Luzern (CH)

(72) Inventors: Konstantin Victorovich LAKHMAN, Moscow (RU); Aleksandr Aleksandrovich CHIGORIN, Moskovskaya obl (RU); Viktor Sergeevich YURCHENKO, Altaysky kray (RU)

(21) Appl. No.: 16/010,128

(22) Filed: Jun. 15, 2018

(30) Foreign Application Priority Data
Dec. 7, 2017 (RU) 2017142709

(51) Int. Cl. G06F 15/18; G06K 9/62; G06N 3/08; G06F 17/27; G06F 17/30

(52) U.S. Cl. CPC G06F 15/18; G06K 9/6256; G06K 9/6226; G06F 17/30256; G06N 3/08; G06F 17/2765; G06F 17/30864; G06K 9/6223

(57) ABSTRACT

A method and system for generating a set of training objects for a Machine Learning Algorithm (MLA) comprising: obtaining an indication of search queries, each search query being associated with a first set of image search results, generating a query vector for each of the search queries, clustering the query vectors into a plurality of query vector clusters, for each of the query vector clusters, associating a second set of image search results, the second set of image search results including at least a portion of each first set of image search results associated with the query vectors that are part of each of the respective query vector clusters, and for each of query vector clusters, storing each image search result of the second set of image search results as a training object in a set of training objects, each image search result being associated with a cluster label.

### CROSS-REFERENCE

The present application claims priority to Russian Patent Application No. 2017142709, entitled “Method of and System for Generating a Training Set for a Machine Learning Algorithm,” filed Dec. 7, 2017, the entirety of which is incorporated by reference herein.

### FIELD

The present technology relates to machine learning algorithms in general and, more specifically, to a method of and a system for generating a training set for training a machine learning algorithm.

### BACKGROUND

Improvements in computer hardware and technology coupled with the multiplication of connected mobile electronic devices have amplified interest in developing artificial intelligence and solutions for task automatization, outcome prediction, information classification and learning from experience, resulting in the field of machine learning. Machine learning, closely related to data mining, computational statistics and optimization, explores the study and construction of algorithms that can learn from and make predictions based on data.

The field of machine learning has evolved extensively in the last decade, giving rise to effective web search, image recognition, speech recognition, self-driving cars, personalization, and understanding of the human genome, among others.

Computer vision, also known as machine vision, is a branch of machine learning that deals with the automatic extraction, analysis and understanding of useful information from a single image or a sequence of images. One common task for a computer vision system is to classify an image into a category based on features extracted from the image. As an example, a computer vision system may classify images as containing nudity or not for purpose of censorship (as part of parental control applications, for example).

Neural networks (NN), and deep learning have been proven to be useful machine learning techniques in computer vision, speech recognition, pattern and sequence recognition, data mining, translation, and information retrieval, among others. Briefly speaking, neural networks are typically organized in layers, which are made of a number of interconnected nodes that contain activation functions. Patterns may be presented to the network via an input layer connected to hidden layers, and processing may be done via the weighted connections of nodes. The answer is then output by an output layer connected to the hidden layers.

Machine learning algorithms (MLA) may generally be divided into broad categories such as supervised learning, unsupervised learning and reinforcement learning. Supervised learning involves presenting a machine learning algorithm with training data consisting of inputs and outputs labelled by assessors, where the objective is to train the machine learning algorithm such that it learns a general rule for mapping inputs to outputs. Unsupervised learning involves presenting the machine learning algorithm with unlabeled data, where the objective is for the machine learning algorithm to find a structure or hidden patterns in the data. Reinforcement learning involves having an algorithm evolving in a dynamic environment without providing the algorithm with labeled data or corrections.

An important aspect of supervised learning is providing the machine learning algorithm with a large quantity of quality training datasets, which allows improving the predictive ability of the MLA. Typically, the training datasets are marked by “assessors”, who assign relevancy labels to the documents using a human judgment. Assessors may mark query-document pairs, images, videos, etc. as being relevant or non-relevant, with numerical scores, or any other method.

Different approaches have been developed for training MLAs implementing neural networks and deep learning techniques.

As an example, a first approach involves training the MLA on training examples including images that have been previously labelled by human assessors based on a specific task at hand (for example, classifying images based on a breed of a dog). The MLA is then given unseen data (i.e. images containing a representation of a dog with the aim for the MLA to classify the image based on the breed of the dog). In this case, if the MLA is to be used for a new task (for example, classifying images based on presence or absence of nudity), the MLA needs to be trained with training examples related to the new task.

A second approach, known as transfer learning, involves “pre-training” the MLA on a large dataset of training examples, which may not be specifically relevant to any given task at hand, and subsequently train the MLA on a more specific and smaller dataset for a specific task. Such an approach allows saving time and resources by pre-training the MLA.

U.S. Patent Publication No. 2016/140438 A1 published on May 19, 2016 to Nec Laboratories America Inc. and titled “Hyper-Class Augmented And Regularized Deep Learning For Fine-Grained Image Classification” teaches systems and methods are disclosed for training a learning machine by augmenting data from fine-grained image recognition with labeled data annotated by one or more hyper-classes, performing multi-task deep learning; allowing fine-grained classification and hyper-class classification to share and learn the same feature layers; and applying regularization in the multi-task deep learning to exploit one or more relationships between the fine-grained classes and the hyper-classes.

U.S. Patent Publication No. 2011/258149 A1 published on Apr. 19, 2011 to Microsoft Corp. and titled “Ranking Search Results Using Click-Based Data” teaches methods and computer-storage media having computer-executable instructions embodied thereon that facilitate generating a machine-learned model for ranking search results using click-based data are provided. Data is referenced from user queries, which may include search results generated by general search engines and vertical search engines. A training set is generated from the search results and click-based judgments are associated with the search results in the training set. Based on click-based judgments, identifiable features are determined from the search results in a training set. Based on determining identifiable features in a training set, a rule set is generated for ranking subsequent search results.

U.S. Patent Publication No. 2016/0125274 A1 published on May 5, 2016 to PayPal Inc. and titled “Discovering visual concepts from weakly labeled image collections” teaches that images uploaded to photo sharing websites often include some tags or sentence descriptions. In an example embodiment, these tags or descriptions, which might be relevant to the image contents, become the weak labels of these images. The weak labels can be used to identify concepts for the images using an iterative hard instance learning algorithm to discover visual concepts from the label and visual feature representations in the weakly labeled images. The visual concept detectors can be directly applied to concept recognition and detection.

### SUMMARY

Developers of the present technology have appreciated at least one technical problem associated with the prior art approaches for generating training sets for machine learning algorithms.

Developers of the present technology have appreciated that an MLA implementing neural networks and deep learning algorithms requires an extensive number of documents during the training phase. While having documents labelled by human assessors is a viable approach, the sheer amount of documents that needs to be labelled by assessors renders the task tedious, time consuming and expensive. The assessor labels also tend to suffer from an individual assessor bias, especially when labelling requires application of a subjective judgment (for example, in terms of relevancy of an image to a particular search query, etc.).

More specifically, developers of the present technology have appreciated that while massive open public datasets such as ImageNet™ dataset may be useful for generating training datasets for training and pre-training an MLA, such datasets are biased towards certain categories of images, do not necessarily contain enough image classes, and do not necessarily correspond to what users are generally searching in an image vertical search.

Furthermore, datasets with user generated tags and text are not necessarily relevant to the task at hand (and may be considered to be of low quality for the purposes of training).

Developers of the present technology have appreciated that search engine operators, such as Google™, Yandex™, Bing™ and Yahoo™, among others, have access to a large amount of user interaction data with respect to search results appearing in response to user queries. In particular, search engines typically execute “vertical searches”, which include an image vertical. In other words, when a given user is searching for images, the typical search engine presents results from an image vertical. The given user can then “interact” with such image vertical search results, the interactions including previewing, skipping, selecting, etc.

Thus, embodiments of the present technology are directed to a method and a system for generating a training set for a machine learning algorithm based on user interaction data obtained from a search engine log.

According to a first broad aspect of the present technology, there is provided method for generating a set of training objects for a Machine Learning Algorithm (MLA), the MLA for categorization of images, the method executable at a server that executes the MLA, the method comprising: obtaining, from a search log, an indication of search queries having been executed in an image vertical search, each search query being associated with a first set of image search results, generating a query vector for each of the search queries, clustering the query vectors into a plurality of query vector clusters, for each of the query vector clusters, associating a second set of image search results, the second set of image search results including at least a portion of each first set of image search results associated with the query vectors that are part of each of the respective query vector clusters, and generating a set of training objects by storing, for each of the query vector clusters, each image search result of the second set of image search results as a training object in the set of training objects, each image search result being associated with a cluster label, the cluster label being indicative of the query vector cluster the image search result is associated with.

In some implementations, generating the query vector comprises applying a word embedding algorithm to each search query.

In some implementations, the method further comprises, prior to the associating the second set of image of images search results for each of the query vector clusters: for each of the first set of image search results, acquiring a respective set of metrics, each respective metric of the respective set of metrics being indicative of user interactions with a respective image search result in the first set of image search results, and wherein the associating the second set of image search results for each of the query vector clusters comprises: selecting the at least the portion of each first set of image search results included in the second set of image search results based on the respective metrics of the image search results in the first set of image search results being over a predetermined threshold.

In some implementations, the query vector clusters are generated based on a proximity of the query vectors in an N-dimensional space.

In some implementations, the word embedding algorithm is one of: word2vec, global vectors for word representation (GloVe), LDA2Vec, sense2vec and wang2vec.

In some implementations, the clustering is performed by using one of: a k-means clustering algorithm, an expectation maximization clustering algorithm, a farthest first clustering algorithm, a hierarchical clustering algorithm, a cobweb clustering algorithm and a density clustering algorithm.

In some implementations, each image search result of the first set of image search results is associated with a respective metric, the respective metric being indicative of user interactions with the image search result, and wherein the generating the query vector comprises: generating a feature vector for each image search result of a selected subset of image search results associated with the search query, weighting each feature vector by the associated respective metric, and aggregating the feature vectors weighted by the associated respective metrics.

In some implementations, the method further comprises, prior to generating the feature vector for each image search result of the selected subset of image search results: selecting at least a portion of each first set of image search results included in the selected subset of image search results based on the respective metrics of the image search results in the first set of image search results being over a predetermined threshold.

In some implementations, the second set of image search results includes all of the image search results of the first set of image search results associated with the query vectors that are part of each of the respective clusters.

In some implementations, the respective metric is one of: a click-through ratio (CTR), and a number of clicks.

In some implementations, the clustering is performed by using one of: a k-means clustering algorithm, an expectation maximization clustering algorithm, a farthest first clustering algorithm, a hierarchical clustering algorithm, a cobweb clustering algorithm and a density clustering algorithm.

According to a second broad aspect of the present technology, there is provided a method for training a Machine Learning Algorithm (MLA), the MLA for categorization of images, the method executable at a server that executes the MLA, the method comprising: obtaining, from a search log, an indication of search queries having been executed in an image vertical search, each search query being associated with a first set of image search results, each of the image search results being associated with a respective metric, the respective metric being indicative of user interactions with the image search result, for each search query, selecting image search results of the first set of image search results having a respective metric over a predetermined threshold to add to a respective selected subset of image search results, generating a feature vector for each image search result of the respective selected subset of image search results associated with each search query, generating a query vector for each of the search queries based on the feature vectors and the respective metrics of the image search results of the respective selected subset of image search results, clustering the query vectors into a plurality of query vector clusters, for each of the query vector clusters, associating a second set of image search results, the second set of image search results including the respective selected subsets of image search results associated with the query vectors that are part of each of the respective query vector clusters, generating a set of training objects by storing, for each of the query vector clusters, each image search result of the second set of image search results as a training object in the set of training objects, each image search result being associated with a cluster label, the cluster label being indicative of the query vector cluster the image search result is associated with, and training the MLA to categorize images using the stored set of training objects.

In some implementations, the training is a first phase training for coarse training of the MLA to categorize images.

In some implementations, the method further comprising fine training the MLA using an additional set of fine-tuned training objects.

In some implementations, the MLA is an artificial neural network (ANN) learning algorithm.

In some implementations, the MLA is a deep learning algorithm.

According to a third broad aspect of the present technology, there is provided a system for generating a set of training objects for a Machine Learning Algorithm (MLA), the MLA for categorization of images, the system comprising: a processor, a non-transitory computer-readable medium comprising instructions, the processor, upon executing the instructions, being configured to: obtain, from a search log, an indication of search queries having been executed in an image vertical search, each search query being associated with a first set of image search results, generate a query vector for each of the search queries, cluster the query vectors into a plurality of query vector clusters, for each of the query vector clusters, associate a second set of image search results, the second set of image search results including at least a portion of each first set of image search results associated with the query vectors that are part of each of the respective query vector clusters, and generate a set of training objects by storing, for each of the query vector clusters, each image search result of the second set of image search results as a training object in the set of training objects, each image search result being associated with a cluster label, the cluster label being indicative of the query vector cluster the image search result is associated with.

In some implementations, each image search result of the first set of image search results is associated with a respective metric, the respective metric being indicative of user interactions with the image search result, and wherein to generate the query vector, the processor is configured to: generate a feature vector for each image search result of a selected subset of image search results associated with the search query, weight each feature vector by the associated respective metric, and aggregate the feature vectors weighted by the associated respective metrics.

In some implementations, the processor is further configured to, prior to generating the feature vector for each image search result of the selected subset of image search results: select at least a portion of each first set of image search results included in the selected subset of image search results based on the respective metrics of the image search results in the first set of image search results being over a predetermined threshold.

In some implementations, the second set of image search results includes all of the image search results of the first set of image search results associated with the query vectors that are part of each of the respective clusters.

In the context of the present specification, a “server” is a computer program that is running on appropriate hardware and is capable of receiving requests (e.g. from electronic devices) over a network, and carrying out those requests, or causing those requests to be carried out. The hardware may be one physical computer or one physical computer system, but neither is required to be the case with respect to the present technology. In the present context, the use of the expression a “server” is not intended to mean that every task (e.g. received instructions or requests) or any particular task will have been received, carried out, or caused to be carried out, by the same server (i.e. the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expression “at least one server”.

In the context of the present specification, “electronic device” is any computer hardware that is capable of running software appropriate to the relevant task at hand. Thus, some (non-limiting) examples of electronic devices include personal computers (desktops, laptops, netbooks, etc.), smartphones, and tablets, as well as network equipment such as routers, switches, and gateways. It should be noted that a device acting as an electronic device in the present context is not precluded from acting as a server to other electronic devices. The use of the expression “a electronic device” does not preclude multiple electronic devices being used in receiving/sending, carrying out or causing to be carried out any task or request, or the consequences of any task or request, or steps of any method described herein.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers.

In the context of the present specification, the expression “information” includes information of any nature or kind whatsoever capable of being stored in a database. Thus information includes, but is not limited to audiovisual works (images, movies, sound records, presentations etc.), data (location data, numerical data, etc.), text (opinions, comments, questions, messages, etc.), documents, spreadsheets, etc.

In the context of the present specification, the expression “computer usable information storage medium” is intended to include media of any nature and kind whatsoever, including RAM, ROM, disks (CD-ROMs, DVDs, floppy disks, hard drivers, etc.), USB keys, solid state-drives, tape drives, etc.

In the context of the present specification, unless expressly provided otherwise, an “indication” of an information element may be the information element itself or a pointer, reference, link, or other indirect mechanism enabling the recipient of the indication to locate a network, memory, database, or other computer-readable medium location from which the information element may be retrieved. For example, an indication of a document could include the document itself (i.e. its contents), or it could be a unique document descriptor identifying a file with respect to a particular file system, or some other means of directing the recipient of the indication to a network location, memory address, database table, or other location where the file may be accessed. As one skilled in the art would recognize, the degree of precision required in such an indication depends on the extent of any prior understanding about the interpretation to be given to information being exchanged as between the sender and the recipient of the indication. For example, if it is understood prior to a communication between a sender and a recipient that an indication of an information element will take the form of a database key for an entry in a particular table of a predetermined database containing the information element, then the sending of the database key is all that is required to effectively convey the information element to the recipient, even though the information element itself was not transmitted as between the sender and the recipient of the indication.

In the context of the present specification, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first server” and “third server” is not intended to imply any particular order, type, chronology, hierarchy or ranking (for example) of/between the server, nor is their use (by itself) intended imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 depicts a diagram of a system implemented in accordance with non-limiting embodiments of the present technology.

FIG. 2 depicts a schematic representation of a first training sample generator in accordance with embodiments of the present technology.

FIG. 3 depicts a schematic representation of a second training sample generator in accordance with embodiments of the present technology.

FIG. 4 depicts a block diagram of a method implementing the first training sample generator, the method executable within the system of FIG. 1.

FIG. 5 depicts a block diagram of a method implementing the second training sample generator, the method executable within the system of FIG. 1.

### DETAILED DESCRIPTION

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labeled as a “processor” or a “graphics processing unit”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. In some embodiments of the present technology, the processor may be a general purpose processor, such as a central processing unit (CPU) or a processor dedicated to a specific purpose, such as a graphics processing unit (GPU). Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown.

With these fundamentals in place, we will now consider some non-limiting examples to illustrate various implementations of aspects of the present technology.

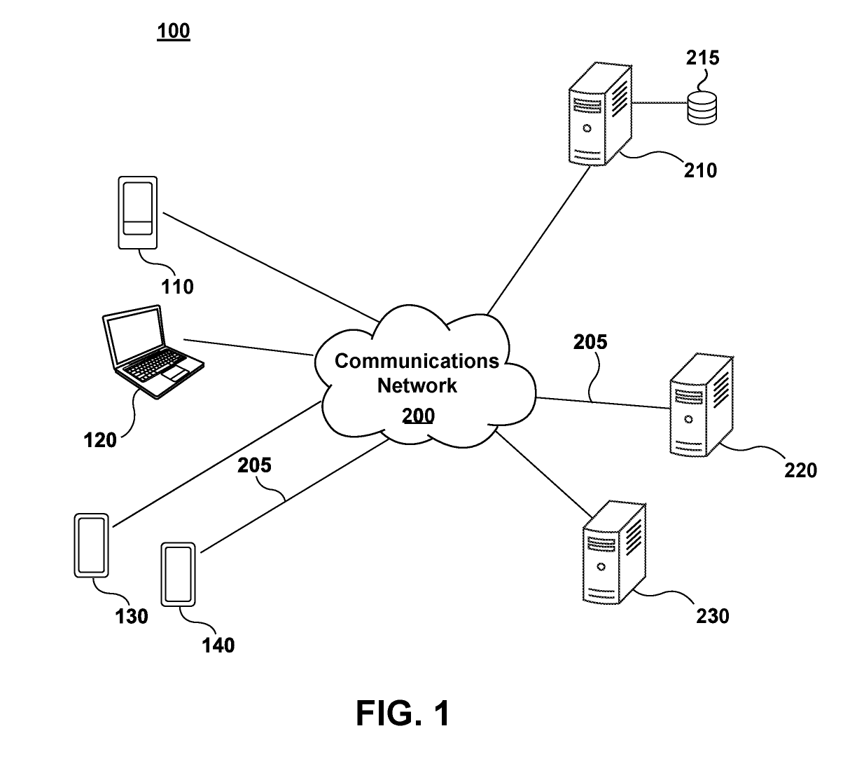

With reference to FIG. 1, there is depicted a system 100, the system 100 implemented according to embodiments of the present technology. The system 100 comprises a first client device 110, a second client device 120, a third client device 130, and a fourth client device 140 coupled to a communications network 200 via a respective communication link 205. The system 100 comprises a search engine server 210, an analytics server 220 and a training server 230 coupled to the communications network 200 via their respective communication link 205.

As an example only, the first client device 110 may be implemented as a smartphone, the second client device 120 may be implemented as a laptop, the third client device 130 may be implemented as a smartphone and the fourth client device 140 may be implemented as a tablet. In some non-limiting embodiments of the present technology, the communications network 200 can be implemented as the Internet. In other embodiments of the present technology, the communications network 200 can be implemented differently, such as any wide-area communications network, local-area communications network, a private communications network and the like.

How the communication link 205 is implemented is not particularly limited and will depend on how the first client device 110, the second client device 120, the third client device 130 and the fourth client device 140 are implemented. Merely as an example and not as a limitation, in those embodiments of the present technology where at least one of the first client device 110, the second client device 120, the third client device 130 and the fourth client device 140 is implemented as a wireless communication device (such as a smart-phone), the communication link 205 can be implemented as a wireless communication link (such as but not limited to, a 3G communications network link, a 4G communications network link, a Wireless Fidelity, or WiFi® for short, Bluetooth® and the like). In those examples, where at least one of the first client device 110, the second client device 120, the third client device 130 and the fourth client device 140 are implemented respectively as laptop, smartphone, tablet computer, the communication link 205 can be either wireless (such as the Wireless Fidelity, or WiFi® for short, Bluetooth® or the like) or wired (such as an Ethernet based connection).

It should be expressly understood that implementations for the first client device 110, the second client device 120, the third client device 130, the fourth client device 140, the communication link 205 and the communications network 200 are provided for illustration purposes only. As such, those skilled in the art will easily appreciate other specific implementational details for the first client device 110, the second client device 120, the third client device 130, the fourth client device 140 and the communication link 205 and the communications network 200. As such, by no means, examples provided herein above are meant to limit the scope of the present technology.

While only four client devices 110, 120, 130 and 140 are illustrated (all are shown in FIG. 1), it is contemplated that any number of client devices 110, 120, 130 and 140 could be connected to the system 100. It is further contemplated that in some implementations, the number of client devices 110, 120, 130 and 140 included in the system 100 could number in the tens or hundreds of thousands.

Also coupled to the communications network 200 is the aforementioned search engine server 210. The search engine server 210 can be implemented as a conventional computer server. In an example of an embodiment of the present technology, the search engine server 210 can be implemented as a Dell™ PowerEdge™ Server running the Microsoft™ Windows Server™ operating system. Needless to say, the search engine server 210 can be implemented in any other suitable hardware and/or software and/or firmware or a combination thereof. In the depicted non-limiting embodiment of present technology, search engine server 210 is a single server. In alternative non-limiting embodiments of the present technology, the functionality of the search engine server 210 may be distributed and may be implemented via multiple servers. In some embodiments of the present technology, the search engine server 210 is under control and/or management of a search engine operator. Alternatively, the search engine server 210 can be under control and/or management of a service provider.

Generally speaking, the purpose of the search engine server 210 is to (i) execute searches (details will be explained herein below); (ii) execute analysis of search results and perform ranking of search results; (iii) group results and compile the search result page (SERP) to be outputted to an electronic device (such as one of the first client device 110, the second client device 120, the third client device 130 and the fourth client device 140).

How the search engine server 210 is configured to execute searches is not particularly limited. Those skilled in the art will appreciate several ways and means to execute the search using the search engine server 210 and as such, several structural components of the search engine server 210 will only be described at a high level. The search engine server 210 may maintain a search log database 215.

In some embodiments of the present technology, the search engine server 210 can execute several searches, including but not limited to, a general search and a vertical search. The search engine server 210 is configured to perform general web searches, as is known to those of skill in the art. The search engine server 210 is also configured to execute one or more vertical searches, such as an images vertical search, a music vertical search, a video vertical search, a news vertical search, a maps vertical search and the like. The search engine server 210 is also configured to, as is known to those of skill in the art, execute a crawler algorithm—which algorithm causes the search engine server 210 to “crawl” the Internet and index visited web sites into one or more of the index databases, such as the search log database 215.

In parallel or in sequence with the general web search, the search engine server 210 is configured to perform one or more vertical searches within the respective vertical databases, which may be included in the search log database 215. For the purposes of the description presented herein, the term “vertical” (as in vertical search) is meant to connote a search performed on a subset of a larger set of data, the subset having been grouped pursuant to an attribute of data. For example, to the extent that the one of the vertical searches performed by the search engine server 210 is an image service, the search engine server 210 can be said to search a subset (i.e. images) of the set of data (i.e. all the data potentially available for searching), the subset of data being stored in the search log database 215 associated with the search engine server 210.

The search engine server 210 is configured to generate a ranked search results list, including the results from the general web search and the vertical web search. Multiple algorithms for ranking the search results are known and can be implemented by the search engine server 210.

Just as an example and not as a limitation, some of the known techniques for ranking search results by relevancy to the user-submitted search query are based on some or all of: (i) how popular a given search query or a response thereto is in searches; (ii) how many results have been returned; (iii) whether the search query contains any determinative terms (such as “images”, “movies”, “weather” or the like), (iv) how often a particular search query is typically used with determinative terms by other users; and (v) how often other uses performing a similar search have selected a particular resource or a particular vertical search results when results were presented using the SERP. The search engine server 210 can thus calculate and assign a relevance score (based on the different criteria listed above) to each search result obtained in response to a user-submitted search query and generate a SERP, where search results are ranked according to their respective relevance scores.

Also coupled to the communications network 200 is the above-mentioned analytics server 220. The analytics server 220 can be implemented as a conventional computer server. In an example of an embodiment of the present technology, the analytics server 220 can be implemented as a Dell™ PowerEdge™ Server running the Microsoft™ Windows Server™ operating system. Needless to say, the analytics server 220 can be implemented in any other suitable hardware and/or software and/or firmware or a combination thereof. In the depicted non-limiting embodiment of present technology, the analytics server 220 is a single server. In alternative non-limiting embodiments of the present technology, the functionality of the analytics server 220 may be distributed and may be implemented via multiple servers. In other embodiments, the functionality of the analytics server 220 may be performed completely or in part by the search engine server 210. In some embodiments of the present technology, the analytics server 220 is under control and/or management of a search engine operator. Alternatively, the analytics server 220 can be under control and/or management of another service provider.

Generally speaking, the purpose of the analytics server 220 is to track user interactions with search results provided by the search engine server 210 in response to user requests (e.g. made by one of the first client device 110, the second client device 120, the third client device 130 and the fourth client device 140). The analytics server 220 may track user interactions or click-through data when users perform general web searches and vertical web searches on the search engine server 210. The user interactions may be tracked in the form of metrics by the analytics server 220.

Non-limiting examples of metrics tracked by the analytics server 220 include:
Clicks: the number of clicks performed by a user.
Click-through rate (CTR): number of clicks on an element divided by the number of times the element is shown (impressions).
Average query Click Through Rate (CTR): the CTR for a query is 1 if there is one or more clicks, otherwise 0.

Naturally, the above list is non-exhaustive and may include other types of metric without departing from the scope of the present technology.

In some embodiments, the analytics server 220 may store the metrics and associated search results. In other embodiments, the analytics server 220 may transmit the metrics and associated search results to the search log database 215 of the search engine server 210. In alternative non-limiting embodiments of the present technology, the functionality of the analytics server 220 and the search engine server 210 can be implemented by a single server.

Also coupled to the communications network is the above-mentioned training server 230. The training server 230 can be implemented as a conventional computer server. In an example of an embodiment of the present technology, the training server 230 can be implemented as a Dell™ PowerEdge™ Server running the Microsoft™ Windows Server™ operating system. Needless to say, the training server 230 can be implemented in any other suitable hardware and/or software and/or firmware or a combination thereof. In the depicted non-limiting embodiment of present technology, the training server 230 is a single server. In alternative non-limiting embodiments of the present technology, the functionality of the training server 230 may be distributed and may be implemented via multiple servers. In the context of the present technology, the training server 230 may implement in part the methods and system described herein. In some embodiments of the present technology, the training server 230 is under control and/or management of a search engine operator. Alternatively, the training server 230 can be under control and/or management of another service provider.

Generally speaking, the purpose of the training server 230 is to train one or more machine learning algorithms (MLAs) used by the search engine server 210, the analytics server 220 and/or other servers (not depicted) associated with the search engine operator. The training server 230 may, as an example, train one or more machine learning algorithms associated with the search engine operator for optimizing general web searches, vertical web searches, providing recommendations, predicting outcomes, and other applications. The training and optimization of machine learning algorithms may be executed at predetermined periods of time, or when deemed necessary by the search engine operator.

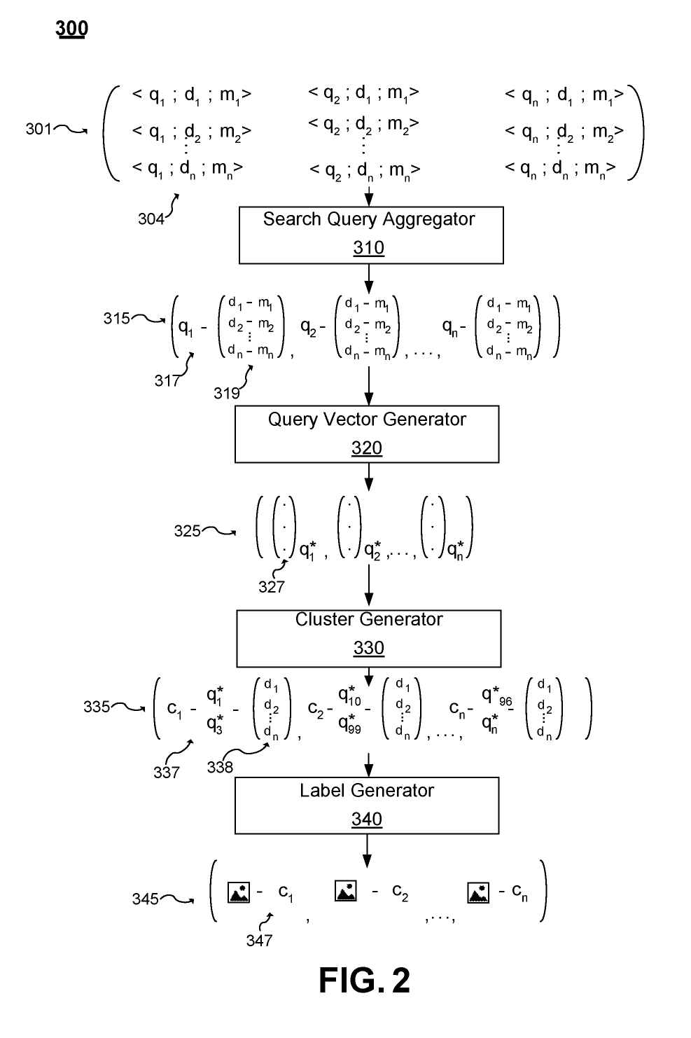

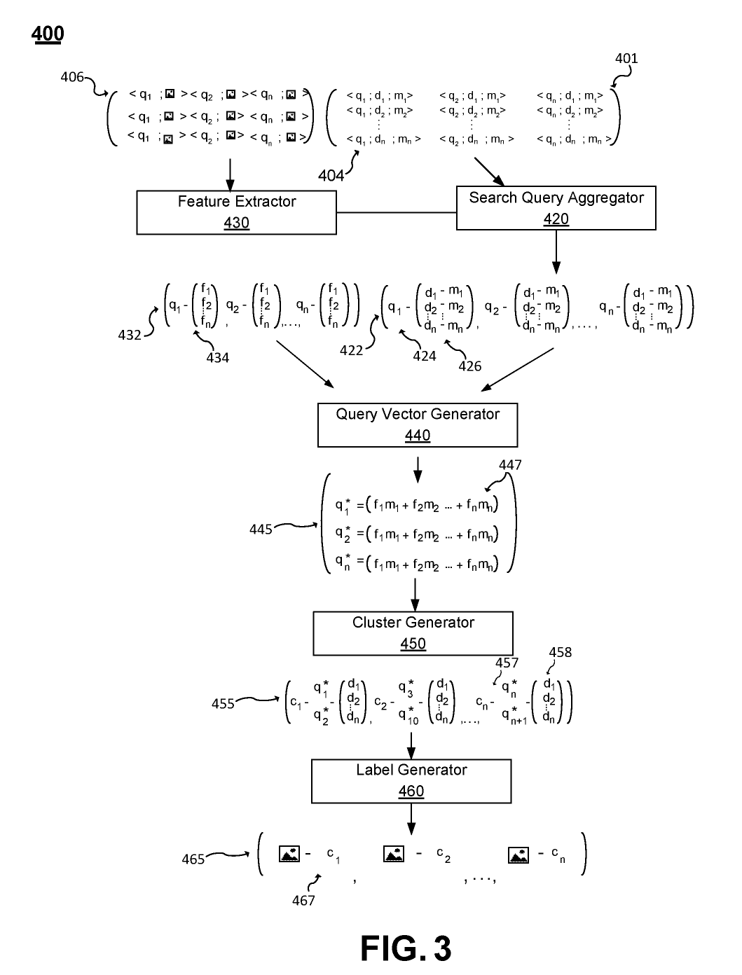

In the embodiments illustrated herein, the training server 230 may be configured to generate training samples for an MLA via a first training sample generator 300 and/or a second training sample generator 400 (depicted in FIG. 2 and FIG. 3, respectively) and the associated methods, which will be described in more detail in the following paragraphs. While the description refers to vertical searches for images and image search results, the present technology may also be applied to general web searches and/or other types of vertical domain searches. Without limiting the generality of the foregoing, the non-limiting embodiments of the present technology can be applied to other types of documents, such as web results, videos, music, news, and other types of searches.

Now turning to FIG. 2, the first training sample generator 300 is illustrated in accordance with non-limiting embodiments of the present technology. The first training sample generator 300 may be executed by the training server 230.

The first training sample generator 300 includes a search query aggregator 310, a query vector generator 320, a cluster generator 330, and a label generator 340. In accordance with the various non-limiting embodiments of the present technology, the search query aggregator 310, the query vector generator 320, the cluster generator 330, and the label generator 340 can be implemented as software routines or modules, one or more purposely-encoded computing devices, firmware, or the combination thereof.

The search query aggregator 310 may generally be configured to retrieve, aggregate, filter and associate together queries, image search results and image metrics. The search query aggregator 310 may retrieve from the search log database 215 of the search engine server 210 an indication of search queries 301, the search queries having been executed by users (e.g. via the first client device 110, the second client device 120, the third client device 130 and the fourth client device 140) in an image vertical search on the search engine server 210. The indication of search queries 301 may generally include (1) search queries, (2) associated image search results, and optionally (3) associated user interaction metrics. The search queries, associated image search results, and associated user interaction metrics may be retrieved from the same database, e.g. the search log database 215 (where it has been pre-processed and stored together), or from different databases, e.g. the search log database 215 and an analytics log database (not depicted) of the analytics server 220 and aggregated by the search query aggregator 310. In some embodiments, only query-document pairs <qₙ; dₙ> may be retrieved, and metrics mₙ associated with each document dₙ may be retrieved at a later time from the search log database 215.

In the embodiment illustrated herein, the indication of search queries 301 includes a plurality of query-document-metric tuples 304 in the form <qₙ; dₙ; mₙ>, where qₙ is a query, dₙ is a document or image search result obtained in response to the query qₙ in an image vertical search on the search engine server 210, and mₙ is the metric associated with the image search result, the metric being indicative of user interactions with the image search result dₙ, e.g. a CTR or a number of clicks.

How the search queries of the plurality of query-document-metric tuples 304 in the indication of search queries 301 are chosen is not limited. The search query aggregator 310 may retrieve, as an example, a pre-determined number of most popular search queries typed by users of the search engine server 210 in a vertical search during a predetermined period of time, e.g. the top 5000 most popular queries q₁, . . . , q₅₀₀₀ (and associated image search results) entered in the search engine server 210 in the last 90 days may be retrieved. In other embodiments, the search queries may be retrieved based on pre-determined search themes, such as humans, animals, machines, nature, etc. In some embodiments, the search queries qₙ may be chosen randomly from the search log database 215 of the search engine server 210. In some embodiments, the search queries in the indication of search queries 301 may be chosen according to various criteria and may depend on the task that needs to be accomplished by the MLA.

Generally, the search query aggregator 310 may retrieve a limited or predetermined number of query-document-metric tuples 304 containing a given query qₙ. In other embodiments, for a given query qₙ, the search query aggregator 310 may retrieve query-document-metric tuples 304 based on a relevance score R(dₙ) of the document dₙ within a given SERP, from the search log database 215 of the search engine server 210. As a non-limiting example, only query-document-metric tuples 304 with documents having a relevance score R(dₙ) over a predetermined threshold value may be retrieved. As another non-limiting example, for a given query qₙ, only a predetermined number of top ranked documents (i.e. the top 100 ranked image search results <q₁; d₁; m₁>, . . . , <q₁; d₁₀₀; m₁₀₀>) obtained in response to the query q₁ may be retrieved. In other embodiments, for a given query qₙ, query-document-metric tuples 304 with metrics over a predetermined threshold may be retrieved, e.g. only query-document-metric tuples 304 with a CTR over 0.6 may be retrieved.

The search query aggregator 310 may then associate each query 317 with a first set of image search results 319, the first set of image search results 319 containing all image search result and associated metrics from the indication of search queries 301 obtained in response to the query 317. The search query aggregator 310 may output a set of queries and image search results 315.

The query vector generator 320 may be configured to receive as an input the set of queries and image search results 315 to output a set of query vectors 325, each query vector 327 of the set of query vectors 325 being associated with a respective query 317 of the set of queries and image search results 315. The query vector generator 320 may execute a word embedding algorithm, and apply the word embedding algorithm to each query 317 of the set of queries and image search results 315 to generate a respective query vector 327. Broadly speaking, the query vector generator 320 may transform text from queries 317 submitted by users into a numerical representation in the form of a query vector 327 of continuous values. The query vector generator 320 may represent queries 317 as low-dimensional vectors by preserving the contextual similarity of words. The word embedding algorithm executed by the query vector generator 320 may be, as a non-limiting example, one of: word2vec, global vectors for word representation (GloVe), LDA2Vec, sense2vec and wang2vec. In some embodiments, each query vector 327 of the set of query vectors 325 may also include the image search results and associated respective metrics. In some embodiments, the set of query vectors 325 may be generated based at least partially on the respective metrics of the image search results of first set of image search results 319 of the set of queries and image search results 315.

The query vector generator 320 may then output the set of query vectors 325.

The cluster generator 330 may be configured to receive as an input the set of query vectors 325 and to output a set of query vector clusters 335. The cluster generator 330 may project the set of query vectors 325 into an N-dimensional feature space, where each query vector 327 of the set of query vectors 325 may represent a point in the N-dimensional feature space. In some embodiments, the N-dimensional space may have less dimensions than the query vectors 327 of the set of query vectors 325. In other embodiments, depending on the clustering method, the cluster generator 330 may cluster the query vectors 327 in the N-dimensional feature space to obtain k clusters or subsets based on a proximity or similarity function. In some embodiments, the number of clusters may be predetermined. Broadly speaking, query vectors 327 part of the same query vector cluster 337 may be more similar to each other than query vectors 327 part of other clusters. As a non-limiting example, the query vectors 327 part of the same cluster may be closely related to each other semantically.

Clustering methods are known in the art, and the clustering may be performed using one of: a k-means clustering algorithm, a fuzzy c-means clustering algorithm, hierarchical clustering algorithms, Gaussian clustering algorithms, quality threshold clustering algorithms, among others.

The cluster generator 330 may then associate a respective second set of image search results 338 to each query vector cluster 337 of the set of query vector clusters 335. The respective second set of image search results 338 may contain at least a portion of each first set of image search results 319 associated with the query vectors 327 part of a given query vector cluster 337. In the present embodiment, the respective second set of image search results 338 contains the entirety of each of the first set of image search results 319. In alternative embodiments of the present technology, the image search results from the first set of image search results 319 that form part of the respective second set of image search results 338 may also be selected or filtered based on the respective metrics associated with each image search result being over a predetermined threshold, e.g. every image search result in each of the first sets of image search results 319 with a CTR over 0.6 may be selected to be added to the second set of image search results 338. In other embodiments, the cluster generator 330 may only consider a predetermined number of image search results regardless of the threshold, e.g. the image search results associated with the top 100 CTR scores may be selected to be added to the second set of image search results 338.

The cluster generator 330 may then output a set of query vector clusters 335, with each query vector cluster 337 being associated with a respective second set of image search results 338.

The label generator 340 may receive as an input the set of query vector clusters 335, each query vector cluster 337 being associated with respective second set of image search results 338. Each image search result of the second set of image search results 338 associated with each query vector cluster 337 may then be labelled by the label generator 340 with a cluster identifier, which may be used as a label for training an MLA on the training server 230. As such, each query vector cluster 337 may be a collection of semantically related queries, with each semantically related query being associated with image search results that best represent the query, as seen by users of the search engine server 210. The image search results part of the same query clusters may thus be labelled with the same label (by virtue of them belonging to the same cluster), and may be used for training an MLA. Thus embodiments of the present technology enable clustering image search results of a given search query and labelling them with a cluster label (by virtue of them belonging to the same cluster). The query vector clusters 337 may or may not be human comprehensible, i.e. the images part of the same clusters may or may not make sense to human, but may nonetheless be useful for pre-training a machine learning algorithm implementing neural networks or deep learning algorithms

The training server 230 may then store each image search result of the second set of image search results 338 with its associated cluster label as a training object 347, to form a set of training objects 345.

The set of training objects 345 may then be used for training a MLA on the training server 230, where the MLA has to classify a proposed image search result in a given cluster after seeing examples of training objects 347. In other embodiments, the set of training objects 345 may be made available to the public for training MLAs.

Generally, the set of training objects 345 may be used for coarse training an MLA in a first training phase to categorize images. The MLA may then be trained in a second training phase on a set of fine-tuned training objects (not depicted) for a specific image classification task.

Now turning to FIG. 3, a second training sample generator 400 is illustrated in accordance with non-limiting embodiments of the present technology. The second training sample generator 400 may be executed by the training server 230.

The second training sample generator 400 includes a feature extractor 430, a search query aggregator 420, a query vector generator 440, a cluster generator 450 and a label generator 460. In accordance with the various non-limiting embodiments of the present technology the feature extractor 430, the search query aggregator 420, the query vector generator 440, the cluster generator 450 and the label generator 460 can be implemented as software routines or modules, one or more purposely-encoded computing devices, firmware, or the combination thereof.

The search query aggregator 420 may generally be configured to retrieve, aggregate, filter and associate together queries, image search results and image metrics. The search query aggregator 420 may retrieve from the search log database 215 of the search engine server 210 an indication of search queries 401, the search queries having been executed by users (e.g. via the first client device 110, the second client device 120, the third client device 130 and the fourth client device 140) in an image vertical search on the search engine server 210. The indication of search queries 401 may generally include (1) search queries, (2) associated image search results, and (3) associated user interaction metrics. The search queries, associated image search results, and associated user interaction metrics may be retrieved from the same database, e.g. the search log database 215 (where it has been pre-processed and stored together), or from different databases, e.g. the search log database 215 and an analytics log database (not depicted) of the analytics server 220 and aggregated by the search query aggregator 310.

In the embodiment illustrated herein, the indication of search queries 401 includes a plurality of query-document-metric tuples 404 in the form <qₙ; dₙ; mₙ>, where qₙ is a query, dₙ is a document or image search result obtained in response to the query qₙ in an image vertical search on the search engine server 210, and mₙ is the metric associated with the image search result dₙ, the metric being indicative of user interactions with the image search result dₙ, e.g. a CTR or a number of clicks.

How the search queries of the plurality of query-document-metric tuples 404 in the indication of search queries 401 are chosen is not limited. The search query aggregator 420 may retrieve, as an example, a pre-determined number of most popular search queries typed by users of the search engine server 210 in a vertical search during a predetermined period of time e.g. the top 5000 most popular queries qₙ (and associated image search results) entered in the search engine server 210 in the last 90 days may be retrieved. In other embodiments, the search queries may be retrieved based on pre-determined search themes, such as humans, animals, machines, nature, etc. In some embodiments, the search queries qₙ may be chosen randomly from the search log database 215 of the search engine server 210. In some embodiments, the search queries in the indication of search queries 401 may be chosen according to various criteria and may depend on the task that needs to be accomplished by the MLA.

Generally, the search query aggregator 420 may retrieve a limited or predetermined number of query-document-metric tuples 404 containing a given query qₙ. In some embodiments, for a given query qₙ, the search query aggregator 420 may retrieve query-document-metric tuples 404 based on the relevance score R(dₙ) of the document dₙ within a given SERP, from the search log database 215 of the search engine server 210. As a non-limiting example, only documents with a relevance score R(dₙ) over a predetermined threshold value may be retrieved. As another non-limiting example, for a given query qₙ, only a predetermined number of top ranked documents (i.e. the top 100 ranked image search results <q₁; d₁; m₁>, . . . ,<q₁; d₁₀₀; m₁₀₀> obtained in response to the query qₙ) may be retrieved. In other embodiments, for a given query qₙ, query-document-metric tuples 404 with metrics over a predetermined threshold may be retrieved e.g. query-document-metric tuples 404 with a CTR over 0.6 may be retrieved.

The search query aggregator 420 may then associate each query 424 with a first set of image search results, the first set of image search results containing all image search result and associated metrics from the indication of search queries 401 obtained in response to the query 424. In embodiments where the query-document-metric tuples 404 have been filtered based on the metrics being over a predetermined threshold, the query-document-metric tuples 404 may be added to a selected subset of image search results 426. The search query aggregator 420 may output a set of queries and image search results 422, witch each query 424 being associated with a respective subset of image search results 426.

The feature extractor 430 may generally be configured to receive as an input a set of images 406 and to output a set of feature vectors 432. The feature extractor 430 may communicate with the search query aggregator 420 to obtain information about images from the image search results to acquire and extract features from. The feature extractor 430 may, as a non-limiting example, obtain identifiers of the image search results that have been filtered by the search query aggregator 420, and retrieve the set of images 406 via the search engine server 210 to extract features. Images in the set of images 406 may correspond to all the images in the selected subsets of image search results 426 of the set of queries and image search results 422. In other embodiments, the functionality of the feature extractor 430 may be integrated with the search query aggregator 420.

The manner in which the feature extractor 430 extracts features from the set of images 406 to obtain the set of feature vectors 432 is not limited. In some non-limiting embodiments of the present technology, the feature extractor 430 can be implemented as a pre-trained neural network (which is configured to analyze images and extract image features form the so-analyzed images). As another non-limiting example, the feature extractor 430 may extract features using one of the following feature extraction algorithms: scale-invariant feature transform (SIFT), histogram of oriented gradients (HOG), Speeded-up robust features (SURF), Local binary patterns (LBP,) Haar wavelets, and Color histograms, among others. The feature extractor 430 may output a set of feature vectors 432, where each feature vector 417 of the set of feature vectors 432 corresponds to a numerical representation of an image obtained in response to a query of the set of search queries 402.

The query vector generator 440 may be configured to receive as an input the set of feature vectors 432 and the set of queries and image search results 422 to output a set of query vectors 445, each query vector 447 of the set of query vectors 445 being associated with a respective query of the set of queries and image search results 422. Broadly speaking, each query vector 447 of the set of query vectors 445 may be a low-dimensional vector representation of the features of the most popular image search results selected by users of the search engine server 210 in response to a given query. In one possible implementation, for a given query, a query vector 447 may be a linear combination of each feature vector 417 of the set of feature vectors 432 weighted by a constant multiplied by the associated respective metric. In other words, each query vector 447 of the set of query vectors 445 may be a weighted average of feature vectors of the image search results of the selected subset of image search results 426 best representing a query, as selected by users interacting with the search engine server 210. In alternative embodiments, a query vector 447 may be a non-linear combination of the respective metrics and the feature vectors.

The cluster generator 450 may be configured to receive as an input the set of query vectors 435 and to output a set of query vector clusters 455. The cluster generator 450 may project the set of query vectors 445 into an N-dimensional feature space, where each query vector 447 of the set of query vectors 445 may represent a point in the N-dimensional feature space. The cluster generator 450 may then cluster the query vectors 447 in the N-dimensional feature space to obtain k clusters or subsets based on a proximity or similarity function (e.g. Manhattan, Squared Euclidean, cosine and Bregman divergence for the k-means clustering algorithm), where query vectors 447 in each cluster are considered similar to each other according to the proximity or similarity function. As a non-limiting example, using the k-means clustering algorithm, k centroids may be defined in the N-dimensional space, and query vectors 447 may be considered to be in a particular cluster if they are closer to a given centroid than any other centroid. Broadly speaking, query vectors 447 in the same cluster may be more similar than query vectors 447 in other clusters. Depending on how the clustering is executed, the query vector clusters 457 may not be human comprehensible i.e. the clusters may not make sense to a human, but may nonetheless be useful for pre-training a machine learning algorithm implementing neural networks or deep learning algorithms, as they contain images that have similar features.

Clustering methods are generally known. As an example, clustering may be performed using one of: a k-means clustering algorithm, a fuzzy c-means clustering algorithm, hierarchical clustering algorithms, Gaussian clustering algorithms, quality threshold clustering algorithms, and others, as it is known in the art.

The cluster generator 450 may then associate a respective second set of image search results 448 to each query vector cluster 457 of the set of query vector clusters 455. The cluster generator 450 may generally analyze each cluster in the set of query vector clusters 455, and retrieve a reference to all images associated with the query vectors 447 included in each query vector cluster 457 in the form a second set of image search results 458.

The cluster generator 450 may then output the set of query vector clusters 455, each query vector cluster 457 of the set of query vector clusters 455 including a plurality of query vectors 447 of the set of query vector clusters 455, each query vector cluster 457 being associated with a respective second set of image search results 458.

The label generator 460 may be configured to receive as an input the set of query vector clusters 455, each query vector cluster 457 being associated with a respective second set of image search results 458, and output a set of training objects 465. The label generator 460 may then label each image search result of the respective second set of image search results 458 with a cluster identifier to obtain training objects 467. The manner in which the cluster identifier is implemented is not limited. As a non-limiting example, each image search result of the second set of image search results 458 may be assigned a numerical identifier. The label generator 460 may retrieve and label the images directly, and save each of the second set of image search results 458 as a set of training objects 465 at the training server 230. In other embodiments, the label generator 460 may associate cluster identifiers to each image in a database (not depicted) of the training server 230.

The set of training objects 465 may then be used for training a MLA on the training server 230. In other embodiments, the set of training objects 465 may be made available to the public in a repository for training MLAs.

Generally, the set of training objects 465 may be used for coarse training an MLA in a first training phase to categorize images. The MLA may then be trained in a second training phase on a set of fine-tuned training objects (not depicted) for a specific image classification task.

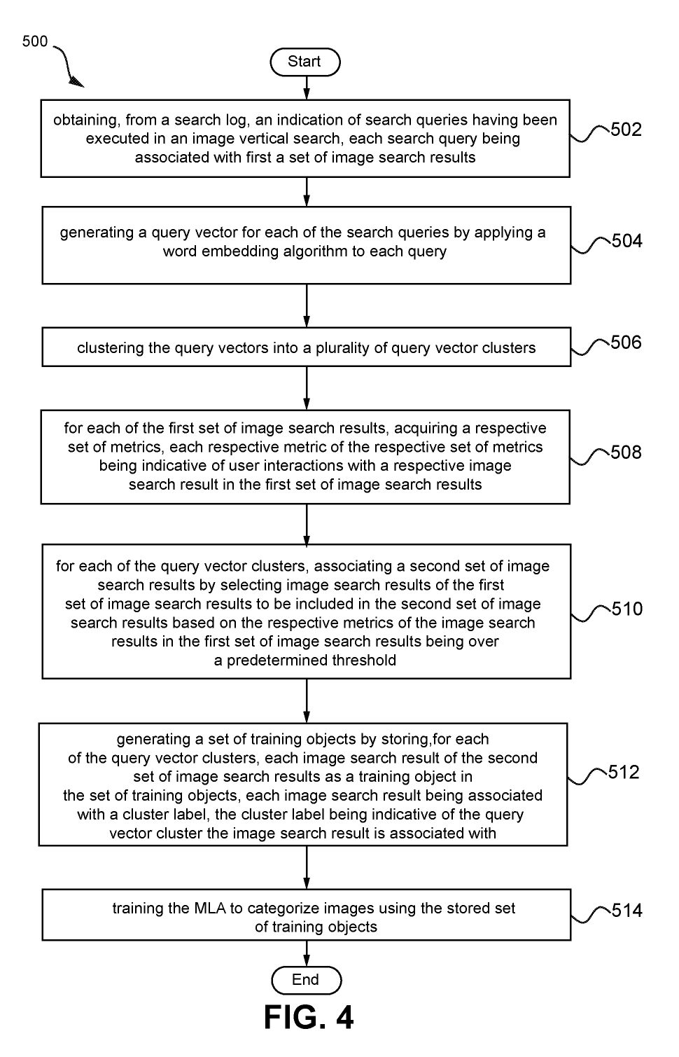

Now turning to FIG. 4, a flowchart of a method 500 of generating a set of training objects for a machine learning algorithm is illustrated. The method 500 is executed with the first training sample generator 300 on the training server 230.

The method 500 may begin at step 502.

STEP 502: obtaining, from a search log, an indication of search queries having been executed in an image vertical search, each search query being associated with first a set of image search results

At step 502, the search query aggregator 310 of the training server 230 may obtain, from the search log database 215 of the search engine server 210, an indication of search queries 301 having been executed in an image vertical search, the indication of search queries 301 having a plurality query-document-metric tuples 304, where each query-document-metric tuple 304 includes a query, an image search result obtained in response to the query and a metric indicative of user interactions with the image search result. The search query aggregator 310 may then output a set of queries and image search results 315, where each query 317 is associated with first a set of image search results 319. In some embodiments, each image search result of the first set of image search results 319 is associated with a respective metric indicative of user interactions with the respective image search result.

The method 500 may then advance to step 504.

STEP 504: generating a query vector for each of the search queries by applying a word embedding algorithm to each query

At step 504, the query vector generator 320 of the training server 230 may generate a set of query vectors 325, the set of query vectors 325 including a query vector 327 for each query of the set of queries and image search results 315. Each query vector 327 may be generated by applying a word embedding algorithm to each query of the set of queries and image search results 315. The word embedding algorithm may be one of: word2vec, global vectors for word representation (GloVe), LDA2Vec, sense2vec and wang2vec. In some embodiments, depending on the clustering method, each query vector 327 of the set of query vectors 325 may represent a point in an N-dimensional feature space.

The method 500 may then advance to step 506.

STEP 506: clustering the query vectors into a plurality of query vector clusters

At step 506, the cluster generator 330 of the training server 230 may cluster the query vectors 327 of the set of query vectors 325 to obtain k clusters or subsets based on a proximity or similarity function. In some embodiments, the clustering may be performed based on a proximity of the query vectors in the N-dimensional feature space. The cluster generator 330 may apply a k-means clustering algorithm, a fuzzy c-means clustering algorithm, hierarchical clustering algorithms, Gaussian clustering algorithms, and quality threshold clustering algorithms.

The method 500 may then advance to step 508.

STEP 508: for each of the first set of image search results, acquiring a respective set of metrics, each respective metric of the respective set of metrics being indicative of user interactions with a respective image search result in the first set of image search results;

At step 508, the search query aggregator 310 and/or the label generator 340 of the training server 230 may acquire, from the search log database 215, for each image search result of each of the first set of image search results 319, a respective set of metrics, each respective metric of the respective set of metrics being indicative of user interactions with a respective image search result in the first set of image search results 319. In some embodiments, the respective metrics for each image search result for each of the first set of image search results 319 may have been acquired at step 502 in the indication of search queries 301.

The method 500 may then advance to step 510.

STEP 510: for each of the query vector clusters, associating a second set of image search results by selecting image search results of the first set of image search results to be included in the second set of image search results based on the respective metrics of the image search results in the first set of image search results being over a predetermined threshold

At step 510, the cluster generator 330 of the training server 230 may associate, for each of the query vector clusters 337 of the set of query vector clusters 335, a second set of image search results 338 by selecting at least a portion of the image search results in the first set of image search results 319 to be included the second set of image search results 338 based on the respective metrics of the image search results in the first set of image search results 319 being over a predetermined threshold.

The method 500 may then advance to step 512.

STEP 512: generating a set of training objects by storing, for each of the query vector clusters, each image search result of the second set of image search results as a training object in the set of training objects, each image search result being associated with a cluster label, the cluster label being indicative of the query vector cluster the image search result is associated with.

At step 512, the label generator 340 of the training server 230 may generate a set of training objects 345 by storing, for each of the query vector clusters 337, each image search result of the second set of image search results 338 as a training object 347 in the set of training objects 345, each image search result being associated with a cluster label, the cluster label being indicative of the query vector cluster 337 the image search result is associated with. The cluster label may be a word, a number or a combination of characters for uniquely identifying a query vector cluster.

The method 500 may then optionally advance to step 514 or end at step 512.

STEP 514: training the MLA to categorize images using the stored set of training objects.

At step 514, the MLA of the training server 230 may be trained by using the set of training objects 345. The MLA may be given examples of image search results and their associated cluster labels, and may then be trained to categorize the images in the different clusters based on the feature vectors extracted from the images.

The method 500 may then end.

Broadly speaking, the first training sample generator 300 and the method 500 allow to generate query clusters of semantically related queries, and associate, for each query part of the query clusters, the most representative image search results with the query clusters, as selected by users of the search engine server 210. Training objects may thus be generated by labelling the image search results part of the same cluster with a given label.

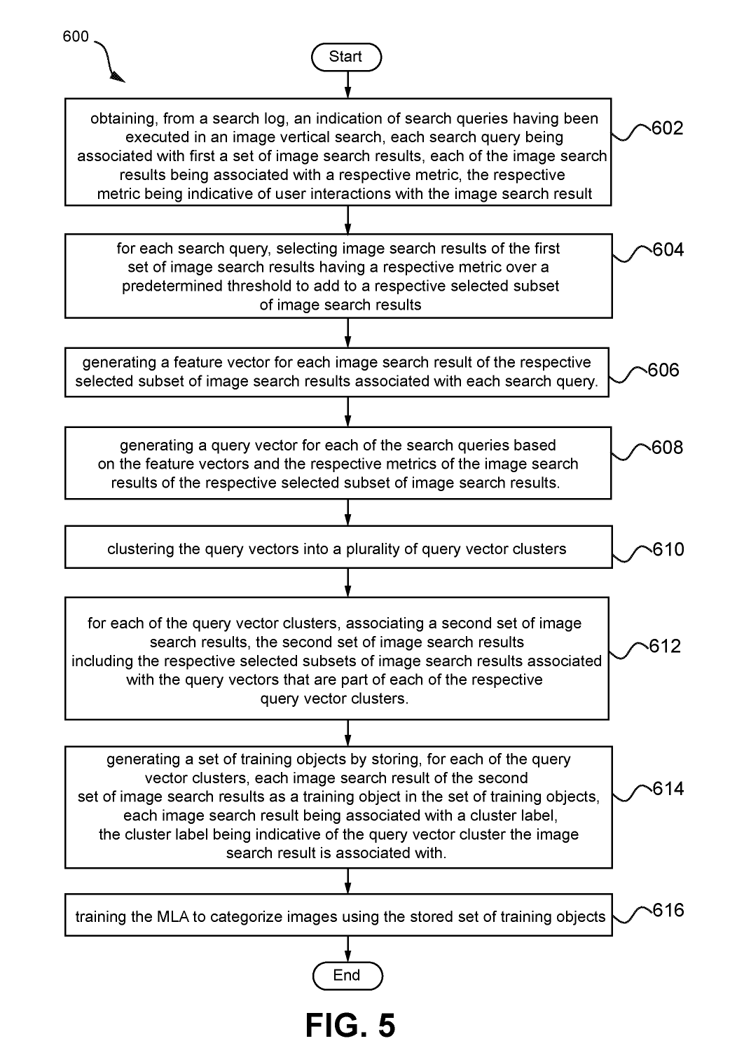

With reference to FIG. 5, a flowchart of a method 600 of generating a set of training objects for a machine learning algorithm is illustrated. The method 600 is executed with the second training sample generator 400 on the training server 230.

The method 600 may begin at step 602.

STEP 602: obtaining, from a search log, an indication of search queries having been executed in an image vertical search, each search query being associated with first a set of image search results, each of the image search results being associated with a respective metric, the respective metric being indicative of user interactions with the image search result

At step 602, the search query aggregator 420 of the training server 230 may obtain, from the search log database 215 of the search engine server 210, an indication of search queries 401 having been executed in an image vertical search on the search engine server 210, the indication of search queries 401 having a plurality query-document-metric tuples 404, where each query-document-metric tuple 404 includes a query, an image search result obtained in response to the query and a metric indicative of user interactions with the image search result. The method 600 may then advance to step 604.

STEP 604: for each search query, selecting image search results of the first set of image search results having a respective metric over a predetermined threshold to add to a respective selected subset of image search results

At step 604, the search query aggregator 420 of the training server 230 may filter each query-document-metric tuple 404 by selecting query-document-metric tuple 404 having respective metric over a predetermined threshold. The search query aggregator 420 may then associate each query 424 with a selected subset of image search results 426 to output a set of queries and image search results 422.

The method 600 may then advance to step 606.

STEP 606: generating a feature vector for each image search result of the respective selected subset of image search results associated with each search query.

At step 606, the feature extractor 430 of the training server 230 may receive information about the selected subset of image search results 426 from the search query aggregator 420, and retrieve a set of images 406, the set of images 406 including the images of each of the selected subset of image search results 426. The feature extractor 430 may then generate a feature vector 434 for each image of the selected subset of image search results 426, and output a set of feature vectors 432.

The method may then advance to step 608.

STEP 608: generating a query vector for each of the search queries based on the feature vectors and the respective metrics of the image search results of the respective selected subset of image search results.

At step 608, the query vector generator 440 of the training server 230 may receive the set of feature vectors 432 and the set of queries and image search results 422 and may then generate, for each query 424 of the set of queries and image search results 422, a query vector 447. Each query vector 447 of the set of query vectors 445 may be generated for a given query 424 by weighting each feature vector 434 of the set of feature vectors 432 by the associated respective metric, and aggregating the feature vectors 434 weighted by the associated respective metrics. In some embodiments, each query vector 447 may be a linear combination of the feature vectors of the most selected image search results weighted by their respective metrics.

The method 600 may the advance to step 610.

STEP 610: clustering the query vectors into a plurality of query vector clusters.

At step 610, the cluster generator 450 of the training server 230 may cluster the query vectors 447 of the set of query vectors 445 to obtain k clusters or subsets based on a proximity or similarity function in the N-dimensional space. The cluster generator 450 may then output a set of query vector clusters 455, each query vector cluster 457 of the set of query vector clusters 455 including a plurality of query vectors 447.

The method 600 may the advance to step 610.

STEP 612: for each of the query vector clusters, associating a second set of image search results, the second set of image search results including the respective selected subsets of image search results associated with the query vectors that are part of each of the respective query vector clusters.

At step 612, for each of the query vector clusters 457 in the set of query vector clusters 455, the label generator 460 of the training server 230 may associate a second set of image search results 458, the second set of image search results 458 including the selected subset of image search results 426 associated with each query vector 447 part of each of the respective query vector clusters 457.

The method 600 may the advance to step 614.

STEP 614: generating a set of training objects by storing, for each of the query vector clusters, each image search result of the second set of image search results as a training object in the set of training objects, each image search result being associated with a cluster label, the cluster label being indicative of the query vector cluster the image search result is associated with.

At step 614, the label generator 460 of the training server 230 may, generate a set of training objects 465 by storing, for each of the query vector clusters 457, each image search result of the second set of image search results 458 as a training object 467 in the set of training objects 465, each image search result being associated with a cluster label, the cluster label being indicative of the query vector cluster 457 the image search result is associated with.

The method 600 may optionally go to step 616 or end.

STEP 616: training the MLA to categorize images using the stored set of training objects.

At step 616, the MLA of the training server 230 may be trained by using the set of training objects 465. The MLA may be given examples of image search results and their associated cluster labels, and may then be trained to categorize the images in the different clusters based on the feature vectors extracted from the images.

The method 600 may then end.

Broadly speaking, the second training sample generator 400 and the method 600 allow to generate clusters from the composite weighted features of the most popular (or all) images search results associated with a query, where each cluster may include the most similar images in term of their feature vectors. Training objects may thus be generated by labelling the image search results part of the same cluster with a given label.

1. A method for generating a set of training objects for a Machine Learning Algorithm (MLA), the MLA for categorization of images, the method executable at a server that executes the MLA, the method comprising:
obtaining, from a search log, an indication of search queries having been executed in an image vertical search, each search query being associated with a first set of image search results;
generating a query vector for each of the search queries;
clustering the query vectors into a plurality of query vector clusters;
for each of the query vector clusters, associating a second set of image search results, the second set of image search results including at least a portion of each first set of image search results associated with the query vectors that are part of each of the respective query vector clusters; and
generating a set of training objects by storing, for each of the query vector clusters, each image search result of the second set of image search results as a training object in the set of training objects, each image search result being associated with a cluster label, the cluster label being indicative of the query vector cluster the image search result is associated with.

2. The method of claim 1, wherein generating the query vector comprises applying a word embedding algorithm to each search query.

3. The method of claim 2, wherein the method further comprises, prior to the associating the second set of images search results for each of the query vector clusters:
for each of the first set of image search results, acquiring a respective set of metrics, each respective metric of the respective set of metrics being indicative of user interactions with a respective image search result in the first set of image search results;
and wherein the associating the second set of image search results for each of the query vector clusters comprises:
selecting the at least the portion of each first set of image search results included in the second set of image search results based on the respective metrics of the image search results in the first set of image search results being over a predetermined threshold.

4. The method of claim 3, wherein the query vector clusters are generated based on a proximity of the query vectors in an N-dimensional space.

5. The method of claim 2, wherein the word embedding algorithm is one of: word2vec, global vectors for word representation (GloVe), LDA2Vec, sense2vec and wang2vec.

6. The method of claim 1, wherein the clustering is performed by using one of: a k-means clustering algorithm, an expectation maximization clustering algorithm, a farthest first clustering algorithm, a hierarchical clustering algorithm, a cobweb clustering algorithm and a density clustering algorithm.

7. The method of claim 1, wherein each image search result of the first set of image search results is associated with a respective metric, the respective metric being indicative of user interactions with the image search result, and wherein the generating the query vector comprises:
generating a feature vector for each image search result of a selected subset of image search results associated with the search query;
weighting each feature vector by the associated respective metric; and
aggregating the feature vectors weighted by the associated respective metrics.

8. The method of claim 7, wherein the method further comprises, prior to generating the feature vector for each image search result of the selected subset of image search results:
selecting at least a portion of each first set of image search results included in the selected subset of image search results based on the respective metrics of the image search results in the first set of image search results being over a predetermined threshold.

9. The method of claim 8, wherein the second set of image search results includes all of the image search results of the first set of image search results associated with the query vectors that are part of each of the respective clusters.

10. The method of claim 7, wherein the respective metric is one of: a click-through ratio (CTR), and a number of clicks.

11. (canceled)

12. A method for training a Machine Learning Algorithm (MLA), the MLA for categorization of images, the method executable at a server that executes the MLA, the method comprising:
obtaining, from a search log, an indication of search queries having been executed in an image vertical search, each search query being associated with a first set of image search results, each of the image search results being associated with a respective metric, the respective metric being indicative of user interactions with the image search result;
for each search query, selecting image search results of the first set of image search results having a respective metric over a predetermined threshold to add to a respective selected subset of image search results;
generating a feature vector for each image search result of the respective selected subset of image search results associated with each search query;
generating a query vector for each of the search queries based on the feature vectors and the respective metrics of the image search results of the respective selected subset of image search results;
clustering the query vectors into a plurality of query vector clusters;
for each of the query vector clusters, associating a second set of image search results, the second set of image search results including the respective selected subsets of image search results associated with the query vectors that are part of each of the respective query vector clusters;
generating a set of training objects by storing, for each of the query vector clusters, each image search result of the second set of image search results as a training object in the set of training objects, each image search result being associated with a cluster label, the cluster label being indicative of the query vector cluster the image search result is associated with; and
training the MLA to categorize images using the stored set of training objects.

13. The method of claim 12, wherein the training is a first phase training for coarse training of the MLA to categorize images.

14. The method of claim 13, wherein the method further comprises fine training the MLA using an additional set of fine-tuned training objects.

15. The method of claim 14, wherein the MLA is an artificial neural network (ANN) learning algorithm.

16. The method of claim 15, wherein the MLA is a deep learning algorithm.

17. A system for generating a set of training objects for a Machine Learning Algorithm (MLA), the MLA for categorization of images, the system comprising:
a processor;
a non-transitory computer-readable medium comprising instructions;
the processor, upon executing the instructions, being configured to:
obtain, from a search log, an indication of search queries having been executed in an image vertical search, each search query being associated with a first set of image search results;
generate a query vector for each of the search queries;
cluster the query vectors into a plurality of query vector clusters;
for each of the query vector clusters, associate a second set of image search results, the second set of image search results including at least a portion of each first set of image search results associated with the query vectors that are part of each of the respective query vector clusters; and
generate a set of training objects by storing, for each of the query vector clusters, each image search result of the second set of image search results as a training object in the set of training objects, each image search result being associated with a cluster label, the cluster label being indicative of the query vector cluster the image search result is associated with.

18. The system of claim 17, wherein each image search result of the first set of image search results is associated with a respective metric, the respective metric being indicative of user interactions with the image search result, and wherein to generate the query vector, the processor is configured to:
generate a feature vector for each image search result of a selected subset of image search results associated with the search query;
weight each feature vector by the associated respective metric; and
aggregate the feature vectors weighted by the associated respective metrics.

19. The system of claim 18, wherein the processor is further configured to, prior to generating the feature vector for each image search result of the selected subset of image search results:
select at least a portion of each first set of image search results included in the selected subset of image search results based on the respective metrics of the image search results in the first set of image search results being over a predetermined threshold.

20. The system of claim 19, wherein the second set of image search results includes all of the image search results of the first set of image search results associated with the query vectors that are part of each of the respective clusters.

21. The system of claim 17, wherein to generate the query vector for each of the search queries, the processor is configured to apply a word embedding algorithm.
